(19) United States
(12) Patent Application Publication
(10) Pub. No.: US 2012/0227318 A1
(43) Pub. Date: Sep. 13, 2012

(54) Plant Training Structure

(76) Inventor: Mark Harger, Colorado Springs, CO (US)

(21) Appl. No.: 13/042,988

(22) Filed: Mar. 8, 2011

(51) Int. Cl. A01G 17/06

(52) U.S. Cl. 47/46

(57) ABSTRACT

A plant training structure is used for training a plant to grow in a direction other than vertically. The plant training structure has a central pillar, a spine, at least one lateral frame arm, and a mesh. The spine is supported by the central pillar and extends in at least two directions away from the central pillar. The at least one lateral frame arm is carried by the spine and disposed on at least two opposing sides of the central pillar. The mesh is attached to and suspended between the lateral frame arms over at least a portion of the central pillar. A plant growing under the plant training structure is restrained from growing vertically by the mesh.

### BACKGROUND

It has been discovered that flowering and fruiting plants produce higher yields when light is more readily available to the whole plant. There are at least two factors which reduce artificial light to much of a plant. First, the upper portions of a plant often block light coming from above, preventing it from reaching lower portions of the plant. Second, light intensity greatly diminishes with increased distance as described by the inverse-square law. The inverse-square law states that as the distance from the light source is increased, the light intensity is diminished relative to the square of the distance. Therefore, a growing structure which alleviates these problems will greatly enhance the yield of a plant.

### DESCRIPTION OF THE DRAWINGS

FIG. 1 is an illustration of an embodiment of the present invention plant training structure.

FIG. 2 is a more detailed illustration of the plant training structure having alternate curved frame arms.

FIG. 3 is an illustration of an embodiment of the pivot assembly of the plant training structure.

### DETAILED DESCRIPTION

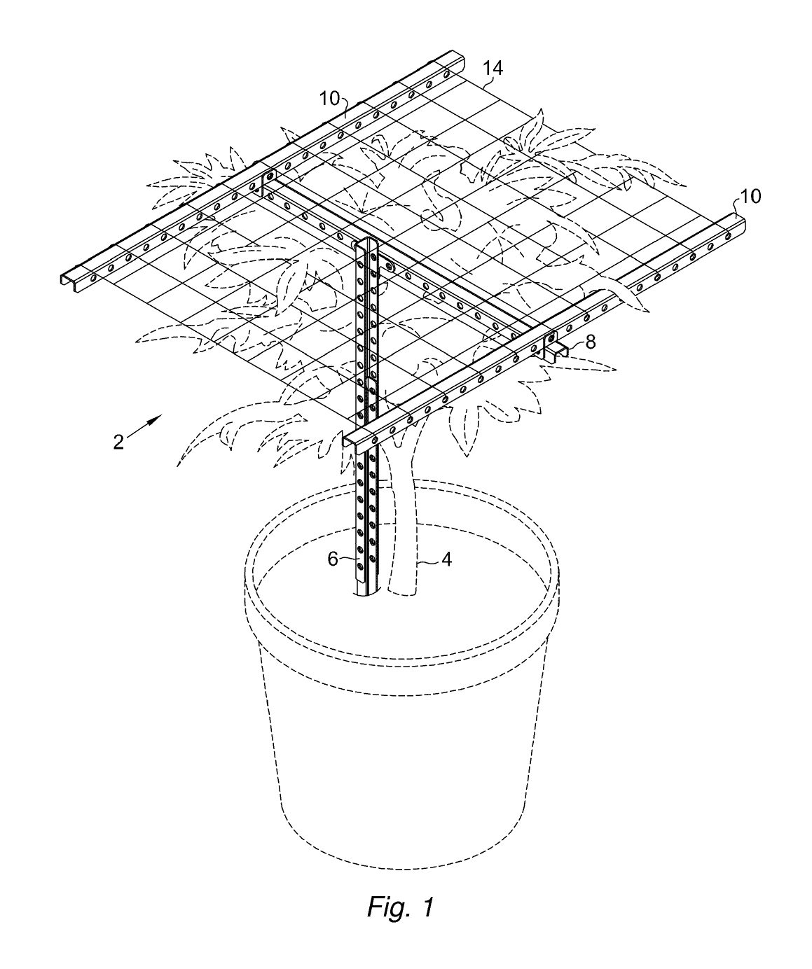

FIG. 1 illustrates an embodiment of the present invention plant training structure 2 for training plant 4 to grow in a direction other than vertically. In one embodiment, plant training structure 2 includes central pillar 6, spine 8, lateral frame arms 10, and mesh 14. Plant 4 growing under plant training structure 2 is restrained from growing vertically by pressure exerted by mesh 14.

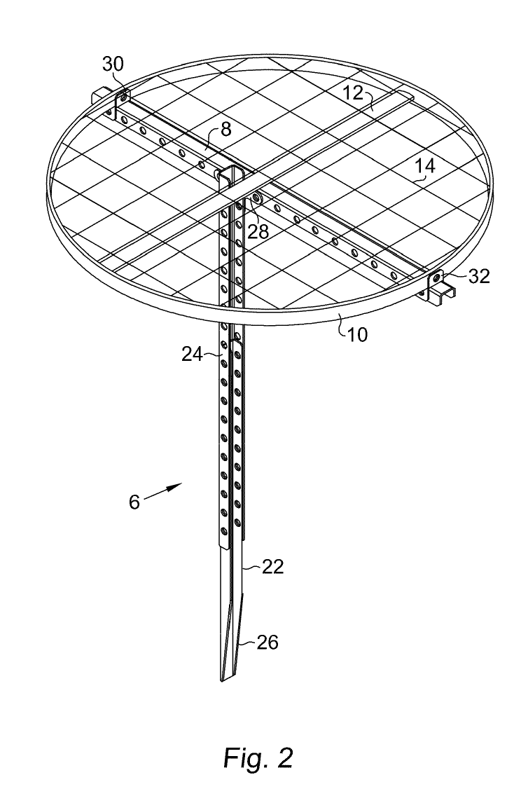

Lateral frame arms 10 are carried by spine 8 and disposed on opposite sides of central pillar 6. As shown in FIG. 1, lateral frame arms 10 are linear. In an alternate embodiment, shown in FIG. 2, only one lateral frame arm 10 is present, but it is curved. An additional brace 12 provides support for curved lateral frame arm 10. The position of the frame arms 10 relative to spine 8 and to central pillar 6 may be fixed or adjustable. As illustrated, lateral frame arms 10 are constructed of perforated metal channel. Alternatively, lateral frame arms 10 may be constructed of any rigid material and may have an adjustable or fixed length. In this embodiment, lateral frame arms 10 are affixed to spine 8 by fixed brackets 30, 32. Brackets 30, 32 may be affixed at any point along lateral frame arms 10 and at any point along spine 8, thus allowing lateral frame arms 10 to be positioned at a variety of offsets from spine 8.

Central pillar 6 is illustrated as being constructed from two pieces 22, 24 of perforated metal channel. One of the pieces 22 has a smaller diameter than the other piece 24. Small piece 22 slides within larger piece to allow the height of central pillar 6 to be adjusted. The two pieces may then be pinned together through the perforations. In addition, smaller piece 22 has a spiked end 26 allowing the piece 22 to be readily inserted into soil near plant 4. Alternatively, central pillar 6 may be constructed of any rigid material and may have an adjustable or fixed height.

Spine 8 is supported by central pillar 6 and extends in at least two directions away from central pillar 6. The position of spine 8 relative to central pillar 6 may be fixed or adjustable. As illustrated, spine 8 is constructed of perforated metal channel. Alternatively, spine 8 may be constructed of any rigid material and may have an adjustable or fixed length. In this embodiment, spine 8 is affixed to central pillar 6 by fixed bracket 28. Bracket 28 may be affixed at any point along spine 8 and at any point along central pillar 6, thus allowing spine 8 to be positioned at a variety of heights and offsets from central pillar 6.

Mesh 14 is attached to and suspended between lateral frame arms 10 over at least a portion of central pillar 6. Mesh 14 may be constructed of any suitable material, such as fiber, metal, wood, or plastic. In one embodiment, mesh 14 is a netting. In an alternate embodiment, mesh 14 is a lattice. In another embodiment, mesh 14 is a screen.

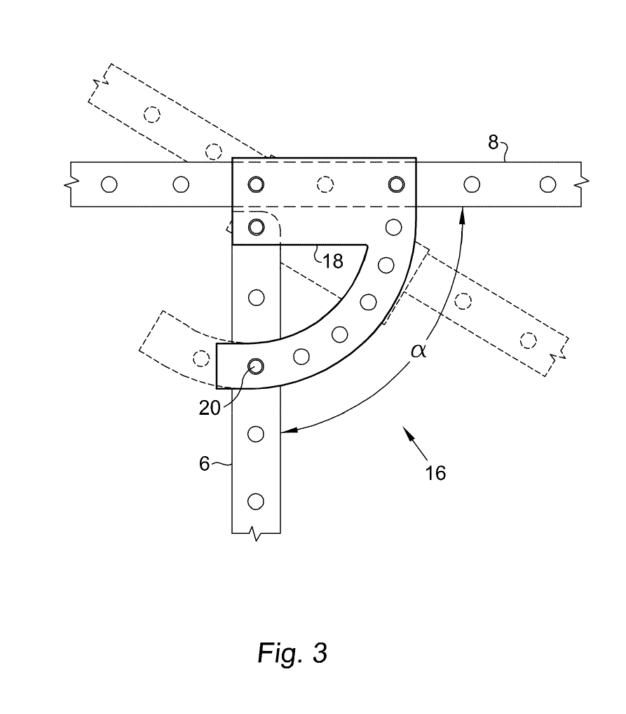

In one embodiment, illustrated in FIG. 3, plant training structure 2 includes pivot assembly 16 affixing spine 8 to central pillar 6, wherein angle a of spine 8 to central pillar 6 is adjustable by tilting pivot assembly 16.

In one embodiment, pivot assembly 16 includes pivot plate 18 and locking mechanism 20. Pivot plate 18 is affixed to spine 8 and pivotally affixed to central pillar 6. Locking mechanism 20 secures pivot plate 18 to central pillar 6 at fixed angle a. In one embodiment, locking mechanism 20 includes a pin 34 inserted in to a hole formed in pivot plate 18 aligned with a hole formed in central pillar 6. Locking mechanism may alternatively be a bolt and wing-nut inserted through a hole in central pillar 6 and through a slot in pivot plate 18.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A plant training structure for training a plant to grow in a direction other than vertically, the plant training structure comprising:
a central pillar;
a spine supported by the central pillar and extending in at least two directions away from the central pillar;
at least one lateral frame arm carried by the spine and disposed on at least two opposing sides of the central pillar;
a mesh attached to and suspended between the at least one lateral frame arm over at least a portion of the central pillar; and
wherein a plant growing under the plant training structure is restrained from growing vertically by the mesh.

2. The plant training structure of claim 1 further including a pivot assembly affixing the spine to the central pillar, wherein an angle of the spine to the central pillar is adjustable by tilting the pivot assembly.

3. The plant training structure of claim 2 wherein the pivot assembly includes
a pivot plate affixed to the spine and pivotally affixed to the central pillar and
a locking mechanism for securing the pivot plate to the central pillar at a fixed angle.

4. The plant training structure of claim 1 wherein the at least one lateral frame arm is at least two linear lateral frame arms.

5. The plant training structure of claim 1 wherein the at least one lateral frame arm is curved.

6. The plant training structure of claim 1 wherein the mesh is a netting.

7. The plant training structure of claim 1 wherein the mesh is a lattice.

8. The plant training structure of claim 1 wherein the position of the spine relative to the central pillar is fixed.

9. The plant training structure of claim 1 wherein the position of the spine relative to the central pillar is adjustable.

10. The plant training structure of claim 1 wherein the position of at least one of the frame arms relative to the spine is fixed.

11. The plant training structure of claim 1 wherein the position of at least one of the frame arms relative to the spine is adjustable.

12. The plant training structure of claim 1 wherein the position of at least one of the frame arms relative to the central pillar is fixed.

13. The plant training structure of claim 1 wherein the position of at least one of the frame arms relative to the central pillar is adjustable.
